(19) United States
(12) Patent Application Publication
(10) Pub. No.: US 2003/0228226 A1
(43) Pub. Date: Dec. 11, 2003

(54) Turbine rotor blade

(75) Inventors: Hirotaka Higashimori, Nagasaki (JP); Katsuyuki Osako, Nagasaki (JP); Takashi Shiraishi, Kanagawa (JP); Takashi Mikogami, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI HEAVY INDUSTRIES, LTD., Tokyo (JP)

(21) Appl. No.: 10/424,729

(22) Filed: Apr. 29, 2003

(30) Foreign Application Priority Data
Jun. 7, 2002 (JP) 2002-167688

(51) Int. Cl. F03B 3/12

(52) U.S. Cl. 416/243

(57) ABSTRACT

A trailing edge of a turbine rotor blade is formed so that a deflection angle of a blade surface in a downstream side of a maximum blade thickness portion is a predetermined value or less, by forming the trailing edge of the rotor blade so as to be inclined from a center line of a blade thickness toward an extension line of a suction surface. Since the trailing edge of the rotor blade is thus formed, a rapid increase of the deflection angle is prevented in a trailing edge portion of the rotor blade. Accordingly, a rapid ascent portion and a rapid deceleration portion are not generated in a suction surface velocity in a main stream unlike the conventional case.

### BACKGROUND OF THE INVENTION

1) Field of the Invention

The present invention relates to a turbine rotor blade that can prevent flow separation in a trailing edge portion of the rotor blade and can prevent a loss of flow from being increased.

2) Description of the Related Art

FIG. 7 and FIG. 8 are cross sectional views of a conventional turbine rotor blade, FIG. 9 is a cross sectional view of the rotor blade shown in FIG. 7 or FIG. 8 in a cross section along a line D-D, and FIG. 10A is a schematic view of a conventional blade surface velocity and FIG. 10B is a schematic view of a separation state of the flow based on a blade shape. FIG. 7 shows a case that a trailing edge of the rotor blade is formed in a parabolic shape, and this case is disclosed by the applicant of the present invention in Japanese Utility Model No. 2599250. Further, FIG. 8 shows a case that the trailing edge of the rotor blade is formed in a linear shape.

As shown in FIG. 7 to Fig. FIG. 9, a plurality of rotor blades 2 provided radially in a circumferential direction of a boss 1 are formed so that a blade thickness t becomes gradually thinner toward a trailing edge 3 of the rotor blade. Since the thickness t of a part just before being thin is generally set to a maximum blade thickness in many cases, this part is called a maximum blade thickness portion and a downstream side of the maximum blade thickness portion 4 is called a trailing edge portion 5, for convenience in explanation.

There are assumed an extension line 6a of a suction surface 6 in an upstream side of the maximum blade thickness portion 4, an extension line 7a of a pressure surface 7 in the upstream side of the maximum blade thickness portion 4, and a center line 8 of the blade thickness t. At this time, the trailing edge 3 of the trailing edge portion 5 based on the conventional technology is designed to be positioned on the center line 8.

A cross section near the trailing edge portion 5 is formed in the manner mentioned above because the blade shape is conventionally planned based on the center line 8, and the blade thickness t is set in such a manner that the blade thickness t is divided into the suction surface 6 and the pressure surface 7 by one half in a perpendicular direction with respect to the center line 8.

However, in the conventional turbine rotor blade, the trailing edge 3 is formed in the manner mentioned above, and therefore a suction surface velocity 9 in a main stream generates a rapid ascent portion 11 due to a rapid increase of a deflection angle θ of flow in the downstream side of the maximum blade thickness portion 4, and generates a rapid deceleration portion 12 running into the trailing edge 3, as shown in FIG. 10A and FIG. 10B. Accordingly, there has been a problem that a separation portion 13 of the flow occurs in the trailing edge portion 5 of the suction surface 6, and a loss of flow is increased.

### SUMMARY OF THE INVENTION

It is an object of the present invention is to solve at least the problems in the conventional technology.

The turbine rotor blade according to one aspect of this invention, includes a suction surface; a pressure surface that intersects the suction surface at a trailing edge; a first portion that is a portion where the turbine rotor blade is most thick; and a second portion that is a portion between the trailing edge and the thick portion and that is inclined toward the suction surface.

The turbine rotor blade according to another aspect of this invention, includes a trailing edge that is formed so as to position on an extension line of a suction surface of the turbine rotor blade in an upstream side of a maximum blade thickness portion of the turbine rotor blade.

The turbine rotor blade according to still another aspect of this invention, includes a trailing edge that is formed so as to be inclined from a center line of a blade thickness of the turbine rotor blade toward an extension line of a suction surface of the turbine rotor blade in an upstream side of a maximum blade thickness portion of the turbine rotor blade.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1A is a cross sectional view of a turbine rotor blade according to a first embodiment of this invention, and FIG. 1B is a cross sectional view of the turbine rotor blade along a line A-A in FIG. 1A;

FIG. 2 is a cross sectional view of a turbine rotor blade whose trailing edge is formed in a linear shape;

FIG. 3A is a schematic view of a blade surface velocity, and FIG. 3B is a schematic view of a state of flow;

FIG. 4A is a cross sectional view of a turbine rotor blade according to a second embodiment of this invention, and FIG. 4B is a schematic view when viewed from a direction B, that is, a downstream direction in FIG. 4A;

FIG. 5 is a cross sectional view of a turbine rotor blade whose trailing edge is formed in a linear shape;

FIG. 6A is a cross sectional view of a turbine rotor blade according to the third embodiment of this invention, and FIG. 6B is a schematic view when viewed from a direction C, that is, a downstream direction in FIG. 6A;

FIG. 7 is a cross sectional view of the conventional turbine rotor blade whose trailing edge is formed in a parabolic shape;

FIG. 8 is a cross sectional view of the conventional turbine rotor blade whose trailing edge is formed in a linear shape;

FIG. 9 is a cross sectional view of the rotor blade along a line D-D of the rotor blade shown in FIG. 7 or FIG. 8; and

FIG. 10A is a schematic view of the conventional blade surface velocity, and FIG. 10B is a schematic view of a separation state of the flow based on the blade shape.

### DETAILED DESCRIPTION

Exemplary embodiments of the turbine rotor blade according to this invention will be explained in detail with reference to the accompanying drawings. The present invention is not limited by the embodiments.

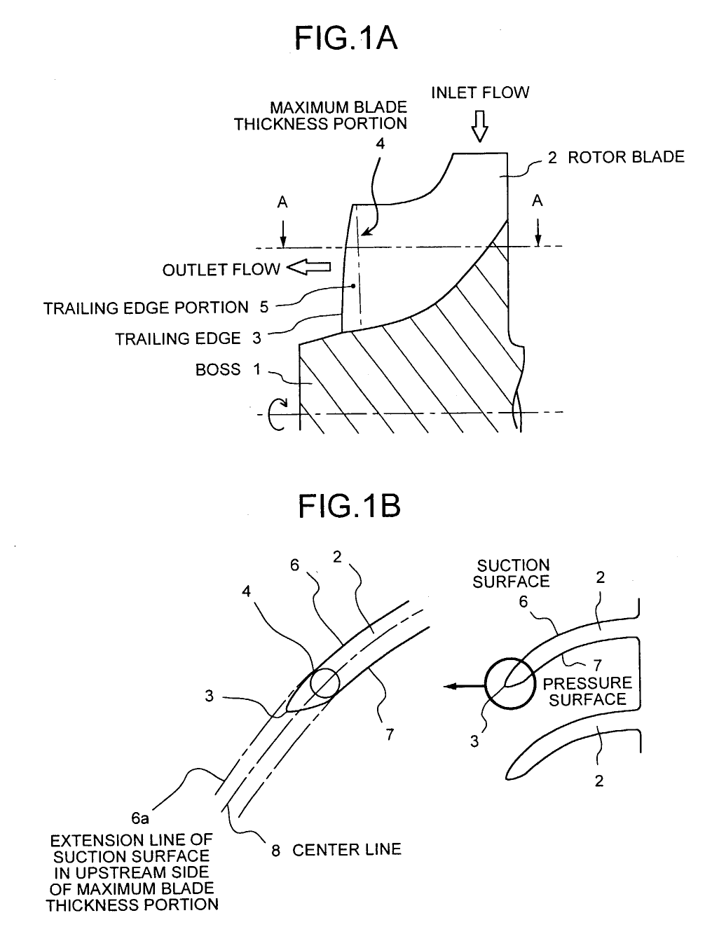

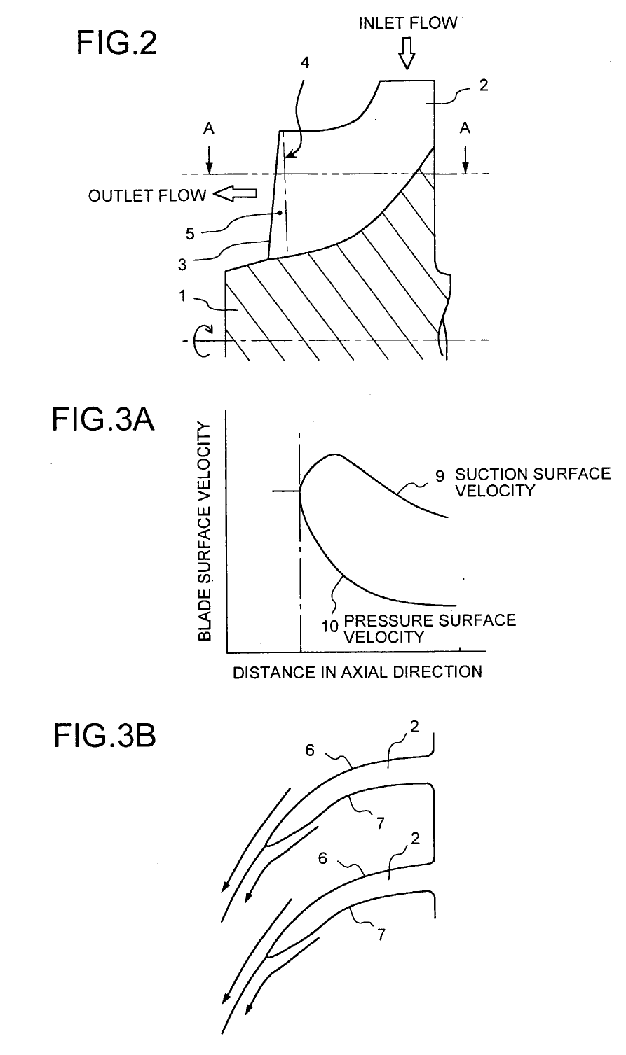

FIG. 1A is a cross sectional view of a turbine rotor blade according to a first embodiment of this invention, and FIG. 1B is a cross sectional view of the turbine rotor blade along a line A-A in FIG. 1A. The first embodiment is an embodiment applied to a rotor blade whose trailing edge is formed in a parabolic shape. FIG. 2 is a cross sectional view of a turbine rotor blade whose trailing edge is formed in a linear shape. FIG. 3A is a schematic view of a blade surface velocity, and FIG. 3B is a schematic view of a state of flow. In this case, in the following description, the same reference numerals are attached to the same members as the already described members or the corresponding members, and an overlapping explanation will be omitted or simplified.

As shown in FIG. 1A and FIG. 1B, the trailing edge 3 of the rotor blade 2 is formed so as to be inclined from the center line 8 of the blade thickness toward the extension line 6a of the suction surface 6 in an upstream side of the maximum blade thickness portion 4, and thereby the trailing edge 3 is formed so that a deflection angle of a blade surface in a downstream side of the maximum blade thickness portion 4 becomes small. In this case, the rotor blade 2 whose trailing edge 3 is formed in a linear shape (refer to FIG. 2) can be formed in the same manner as mentioned above.

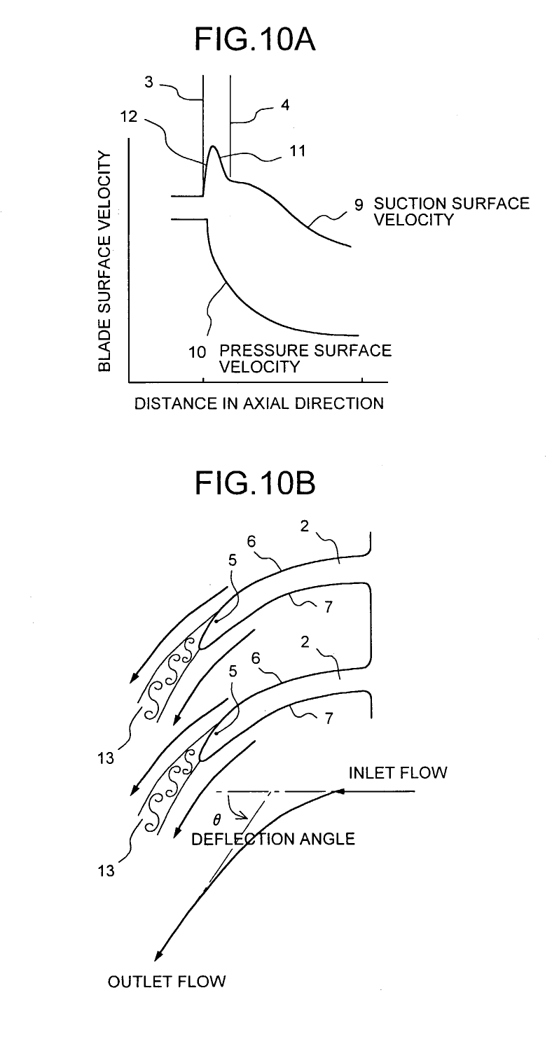

Since the trailing edge 3 of the rotor blade 2 is formed in the manner mentioned above, a rapid increase of the deflection angle is prevented in the trailing edge portion 5. Accordingly, as shown in FIG. 3A and FIG. 3B, since the rapid ascent portion 11 and the rapid deceleration portion 12 (refer to FIG. 10A and FIG. 10B) in the conventional case do not occur in the suction surface velocity 9 in the main stream, it is possible to prevent the separation of the flow in the trailing edge portion 5. Therefore, it is possible to reduce a loss of flow and improve turbine efficiency.

As described above, according to the turbine rotor blade according to the first embodiment, it is possible to prevent the flow from separating in the trailing edge portion 5 and prevent the loss of flow from being increased. Thus, it is possible to improve the turbine efficiency.

In the first embodiment mentioned above, it is assumed that the trailing edge 3 of the rotor blade 2 is formed so as to be inclined from the center line 8 of the blade thickness toward the extension line 6a of the suction surface 6 and thereby the trailing edge 3 is close to the extension line 6a in the upstream side of the maximum blade thickness portion 4. However, the structure is not limited to this, and the trailing edge 3 may be formed so as to be positioned on the extension 6a of the suction surface 6 in the upstream side of the maximum blade thickness portion 4. In this case, the same effect as that mentioned above can be also expected.

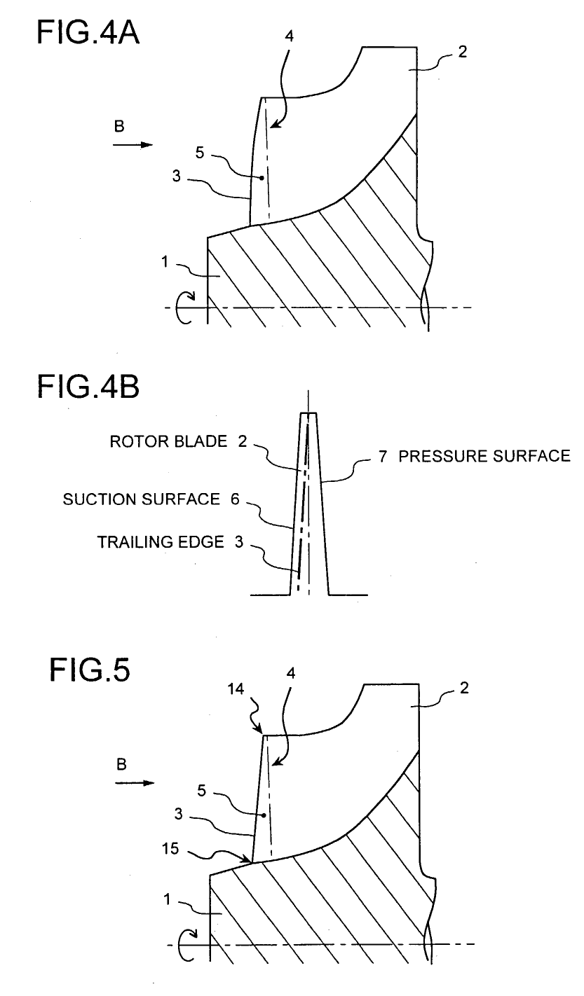

FIG. 4A is a cross sectional view of a turbine rotor blade according to a second embodiment of this invention, and FIG. 4B is a schematic view when viewed from a direction B, that is, a downstream direction in FIG. 4A. The second embodiment corresponds to an embodiment applied to a rotor blade whose trailing edge is formed in a parabolic shape. FIG. 5 is a cross sectional view of a turbine rotor blade whose trailing edge is formed in a linear shape.

In the first embodiment, the trailing edge 3 of the rotor blade 2 is formed so as to be inclined from the center line 8 of the blade thickness toward the extension line 6a of the suction surface 6 and thereby the trailing edge 3 is close to the extension line 6a in the upstream side of the maximum blade thickness portion 4. However, according to the second embodiment, a distribution in a blade height direction of the trailing edge 3 is defined. That is, as shown in FIG. 4B, the trailing edge 3 is formed so as to be inclined toward the side of the suction surface 6 and thereby the trailing edge 3 is close to the suction surface 6 over the whole blade height. In this case, the rotor blade. 2 (refer to FIG. 5) whose trailing edge 3 is formed in the linear shape, can be formed in the same manner as mentioned above.

Since the trailing edge 3 is formed in the same manner as mentioned above, the deflection angle in the trailing edge portion 5 is not rapidly increased, and the rapid ascent portion 11 and the rapid deceleration portion 12 occurring in the conventional case do not occur in the suction surface velocity in the main stream, and therefore it is possible to prevent the flow from separating in the trailing edge portion 5. Accordingly, it is possible to reduce the loss of the flow and improve the turbine efficiency.

As described above, according to the turbine rotor blade of the second embodiment, it is possible to prevent the flow separation in the trailing edge portion 5 and prevent the increase in the loss of flow, thus improving the turbine efficiency.

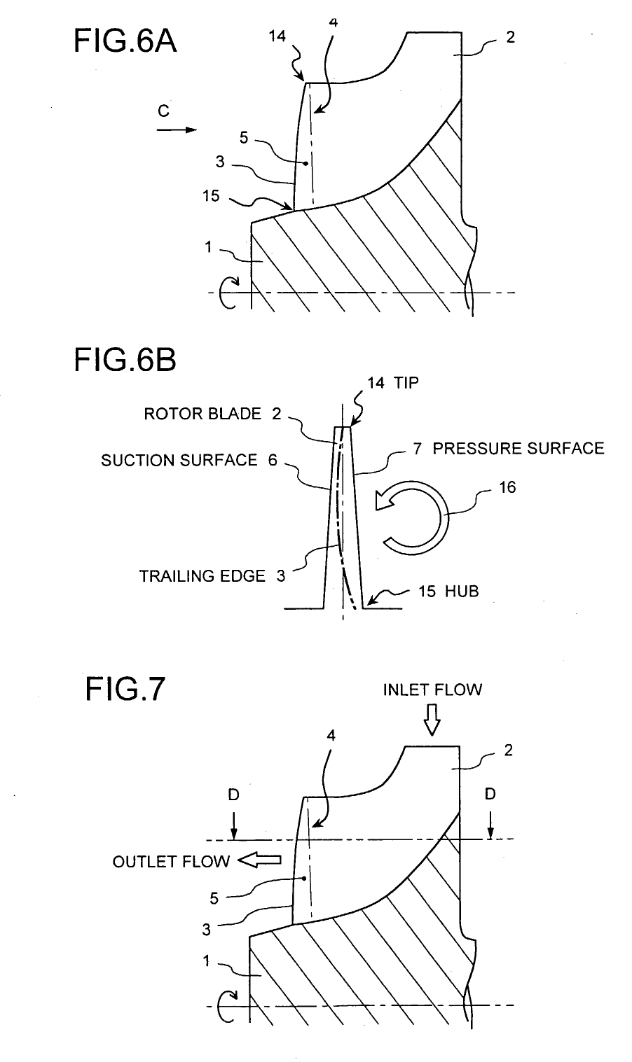

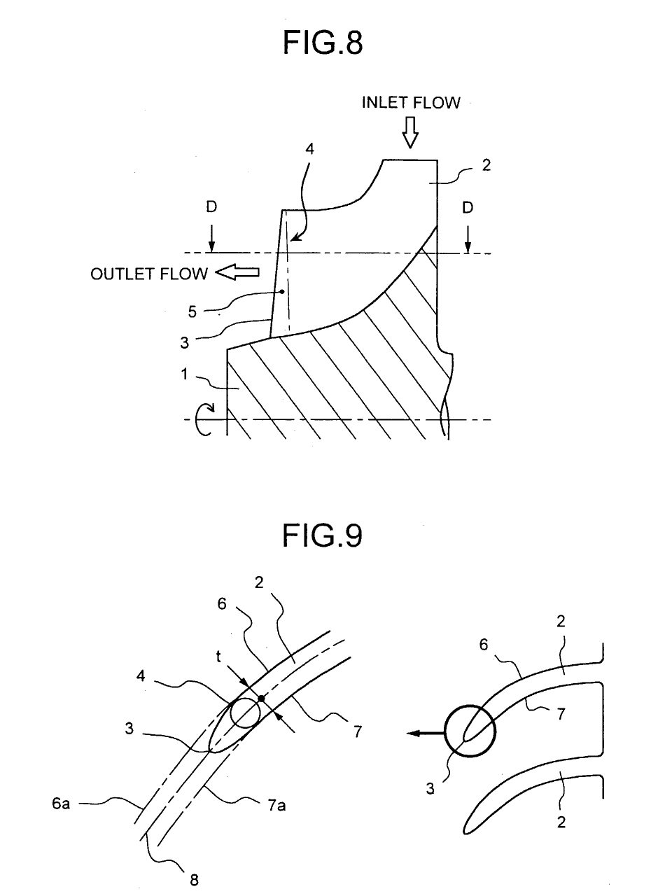

FIG. 6A is a cross sectional view of a turbine rotor blade according to a third embodiment of this invention, and FIG. 6B is a schematic view when viewed from a direction C, that is, a downstream direction in FIG. 6A. The third embodiment is an example applied to a rotor blade whose trailing edge is formed in a parabolic shape.

In the first embodiment, the trailing edge 3 of the rotor blade 2 is formed so as to be inclined from the center line 8 of the blade thickness toward the extension line 6a of the suction surface 6 and therefore the trailing edge 3 is close to the extension line 6a in the upstream side of the maximum blade thickness portion 4. However, according to the second embodiment, a distribution in a blade height direction of the trailing edge 3 is further defined.

That is, when a longitudinal vortex 16 of the main stream is significant as shown in FIG. 6B, the flow is going to move toward the suction surface 6 in the side of a hub 15. Accordingly, the flow is moving along the suction surface 6 without relation to the deflection angle of the blade shape, and no flow separation occurs in some cases in the side of the hub 15.

The trailing edge 3 of the rotor blade 2 is formed so as to be inclined toward the side of the suction surface 6 and thereby the trailing edge 3 is close to the suction surface 6 in the side of a tip 14, and is formed so as to be inclined toward the side of the pressure surface 7 and thereby the trailing edge 3 is close to the pressure surface 7 in the side of the hub 15. In this case, the rotor blade 2 whose trailing edge 3 is formed in the linear shape (refer to FIG. 5) can also be formed in the same manner as mentioned above.

As described above, according to the turbine rotor blade of the third embodiment, it is possible to effectively control the respective flows in the side of the tip 14 and in the side of the hub 15 when the longitudinal vortex 16 of the main stream is significant, and therefore it is possible to reduce the loss of the flow, thus improving the turbine efficiency.

As described above, according to the turbine rotor blade of this invention, the deflection angle of the blade surface in the downstream side of the maximum blade thickness portion is formed small by forming the trailing edge of the rotor blade so as to position on the extension line of the suction surface in the upstream side of the maximum blade thickness portion, or forming the trailing edge of the rotor blade in the inclined manner toward the extension line from the center line of the blade thickness and thereby the trailing edge is close to the extension line in the turbine rotor blade. Therefore, the rapid increase of the deflection angle is prevented in the trailing edge portion, and the rapid ascent or the rapid deceleration occurring in the conventional case is not generated in the suction surface velocity in the main stream, thus, it is possible to prevent the separation of the flow in the trailing edge portion. Accordingly, it is possible to reduce the loss of flow and improve the turbine efficiency.

Furthermore, the trailing edge of the rotor blade is formed so as to be inclined toward the suction surface side and thereby the trailing edge is close to the suction surface over the whole height of the blade. Therefore, it is possible to prevent the separation of the flow over the whole blade height in the trailing edge portion. Accordingly, it is possible to reduce the loss of flow and improve the turbine efficiency.

Moreover, the trailing edge of the rotor blade is formed so as to be inclined toward the suction surface side and thereby the trailing edge is close to the suction surface in the tip side. The the trailing edge is formed so as to be inclined toward the pressure surface side and thereby the trailing edge is close to the pressure surface in the hub side. Therefore, it is possible to-effectively control the flows in the tip side and the hub side, respectively, when the longitudinal vortex of the main stream is significant. Accordingly, it is possible to reduce the loss of flow and improve the turbine efficiency.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A turbine rotor blade comprising:
a suction surface;
a pressure surface that intersects the suction surface at a trailing edge;
a first portion that is a portion where the turbine rotor blade is most thick; and
a second portion that is a portion between the trailing edge and the thick portion and that is inclined toward the suction surface.

2. The turbine rotor blade according to claim 1, wherein the trailing edge as a whole is inclined toward the suction surface.

3. The turbine rotor blade according to claim 1, further comprising:
a blade root that is fastened on a hub; and
a blade tip that is away from the hub,
wherein the trailing edge is inclined so that the blade root is inclined toward the pressure surface and the blade tip is inclined toward the suction surface.

4. A turbine rotor blade comprising a trailing edge that is formed so as to position on an extension line of a suction surface of the turbine rotor blade in an upstream side of a maximum blade thickness portion of the turbine rotor blade.

5. The turbine rotor blade according to claim 4, wherein the trailing edge is formed so that a deflection angle of a surface of the turbine rotor blade in a downstream side of the maximum blade thickness portion is a predetermined value or less.

6. The turbine rotor blade according to claim 4, wherein
the trailing edge is formed so that a tip portion of the turbine rotor blade is inclined toward a suction surface of the turbine rotor blade, and
a root portion of the turbine rotor blade is fixed to a hub and is formed so as to be inclined toward a pressure surface of the turbine rotor blade.

7. A turbine rotor blade comprising a trailing edge that is formed so as to be inclined from a center line of a blade thickness of the turbine rotor blade toward an extension line of a suction surface of the turbine rotor blade in an upstream side of a maximum blade thickness portion of the turbine rotor blade.

8. The turbine rotor blade according to claim 7, wherein the trailing edge is formed so that a deflection angle of a surface of the turbine rotor blade in a downstream side of the maximum blade thickness portion is a predetermined value or less.

9. The turbine rotor blade according to claim 7, wherein
the trailing edge is formed so that a tip portion of the turbine rotor blade is inclined toward a suction surface of the turbine rotor blade, and
a root portion of the turbine rotor blade is fixed to a hub and is formed so as to be inclined toward a pressure surface of the turbine rotor blade.
